(19) United States
(12) Patent Application Publication
(10) Pub. No.: US 2026/0119387 A1
(43) Pub. Date: Apr. 30, 2026

(54) WRITE BURST GATHERING ACROSS MULTIPLE STREAMS

(71) Applicant: Arm Limited, Cambridge (GB)

(72) Inventors: Jamshed Jalal, Austin, TX (US); Leif Christian Bagge, Austin, TX (US); Ashok Kumar Tummala, Cedar Park, TX (US); Randall John Pascarella, Round Rock, TX (US)

(73) Assignee: Arm Limited, Cambridge (GB)

(21) Appl. No.: 19/244,187

(22) Filed: Jun. 20, 2025

Related U.S. Application Data
(60) Provisional application No. 63/714,537, filed on Oct. 31, 2024.

(51) Int. Cl. G06F 12/02

(52) U.S. Cl. CPC G06F 12/023; G06F 2212/1016

(57) ABSTRACT

Write gathering circuitry of a data processing network is configured to receive data streams of cracked writes transmitted across an interconnect. Each data stream is associated with a stream identifier. The write gathering circuitry includes write gathering buffers configured to gather cracked writes from the interconnect in accordance with a stream identifier until the last write of a stream is gathered, the write gathering buffer fills, or the write gathering buffer is evicted for re-use. The gathered writes are transmitted in a gathered write burst via an external interface to the target endpoint of the data processing network. When the write gathering buffer that was allocated to the stream identifier is full, a new write gathering buffer is allocated to the stream identifier, and the new write gathering buffer is marked as a child write gathering buffer of the filled write gathering buffer.

### CROSS-REFERENCE TO RELATED APPLICATIONS

This patent application claims the benefit of U.S. Provisional Application No. 63/714,537, filed Oct. 31, 2024, entitled “WRITE BURST GATHERING ACROSS MULTIPLE STREAMS,” which is hereby incorporated by reference in its entirety.

### BACKGROUND

A data processing network may contain links that use different protocols and different physical connections. For example, Peripheral Component Interconnect Express (PCIe) is a standard that may be used for connecting a processor with peripheral devices. PCIe and similar protocols use a packet-based transaction layer and a point-to-point or peer-to-peer serial physical layer. Another point-to-point protocol is the ARM®AMBA® 5 Advanced extensible Interface (AXI), which is an on-chip communication bus protocol and is part of the Advanced Microcontroller Bus Architecture® (AMBA®) specification of Arm Limited. AXI is a burst-based protocol that uses a multi-byte data bus and allows for multiple data transfers or “data beats” in a single request. The ARM®RAMBA® 5 Coherent Hub Interface (CHI) specification defines interfaces to non-blocking coherent data transfers between multiple connected processors. The protocol is designed for advanced SoC (System-on-Chip) environments where multiple processors, memory controllers, and other components need efficient communication with full cache coherency support. The protocol has a granularity of a cacheline and, while data may be sent in one or more data beats, burst transfers are not available.

Conversion between protocols can result in a loss of efficiency. For example, when a request node of a CHI-based interconnect receives a burst of data from a PCIe controller, the data is split or “cracked” into cacheline sized chunks (e.g., 64-byte or 128-byte chunks) for transmission across the interconnect. When a write burst targets another network peripheral, the write burst is split into one or more cracked writes. The associated home node receives and orders the cracked writes and packages them to send to the target peripheral device. The original burst, which had a single PCIe packet header, is transmitted as multiple packets each with its own header. Since the extra headers occupy time slots on the link, there is reduced bandwidth available for payload data.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a simplified block diagram of a data processing network, in accordance with various representative embodiments.

FIG. 2 is a block diagram of a write gather circuitry of a data processing network, in accordance with various representative embodiments.

FIG. 3 is a block diagram of a write gathering buffer, in accordance with various representative embodiments.

FIG. 4 is a block diagram of a routing logic block showing connections to write gathering buffers, in accordance with various representative embodiments.

FIG. 5 is a block diagram of a response tracker, in accordance with various representative embodiments

FIG. 6 is a flow chart of a method of write gathering in a data processing network, in accordance with various representative embodiments.

FIG. 7 is a flow chart of a method of routing cracked write in a write gather circuitry of a data processing network, in accordance with various representative embodiments.

FIGS. 8-11 illustrate an example of write gathering, in accordance with various representative embodiments.

FIG. 12 is an interaction chart illustrating an example of write gathering, in accordance with various representative embodiments.

### DETAILED DESCRIPTION

The various apparatus and devices described herein provide mechanisms for write gathering in a data processing system.

Various embodiments of the disclosure relate to a Peripheral Home Node (HNP or HN-P) of a data processing network that provides a write gathering feature.

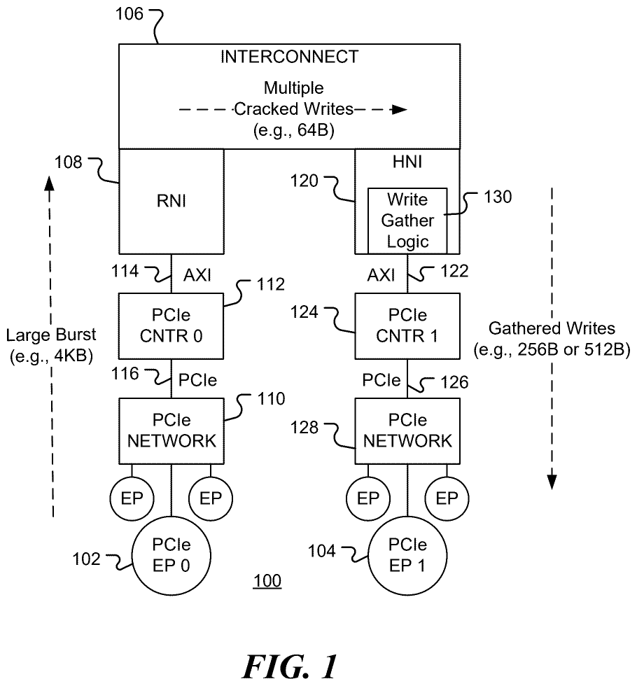

FIG. 1 is a simplified block diagram of a data processing network in accordance with various representative embodiments. Data processing network 100 may be a system-on-a-chip (SoC), for example. Data processing network 100 supports peer-to-peer burst writes between endpoints, such as between first endpoint 102 and second endpoint 104. These endpoints may be coupled, for example, by a Peripheral Component Interconnect Express (PCIe) link and are referred to as PCIe endpoints. Herein, a “write” is taken to mean collection of data transmitted across at least part of network in separate write transaction or operation. The write may include data to be stored in a memory, for example, and may also include metadata, such as the source and intended destination of the data, the quantity of data and the type of data.

In a “burst write,” a device transmits multiple chunks of data sequentially without going through all the steps required to transmit each chunk of data in a separate transaction. In PCIe, for example, multiple bytes (e.g., 4 kilobytes (4 KB)) may be transmitted with a single header.

Referring again to FIG. 1, example data processing network 100 includes a coherent interconnect 106. A coherent interconnect enables coherent sharing of data between multiple caches in a network. Data is transferred in cacheline sized chunks, and burst transfers may not be supported. However, bandwidth is not impaired since the data is transmitted in parallel with the associated metadata. In order for a burst write from an endpoint to be transmitted across coherent interconnect 106, it may be “cracked” or split into cacheline sized writes and sent over the interconnect in one or more cracked writes. In the example shown in FIG. 1, a 4 KB write burst is transmitted from PCIe endpoint 102 to request node 108 via PCIe network 110 and PCIe controller 112. In this example, PCIe controller 112 converts the PCIe burst in an ARM® AMBA® 5 AXI burst on AXI link 114. Request node 108 cracks the burst into multiple, cacheline sized writes for transmission across interconnect 106. A cacheline may be 64 bytes (64B) or 128 bytes (128B), for example. Interconnect 106 may by a coherent hub interface, such as specified in the ARM® AMBA® 5 CHI protocol, for example. Herein, a “cracked write” is taken to a write that is part of a data stream and is available for gathering into a burst write. Cracked writes may be generated individually or generated by splitting up a burst at a previous point in a transmission path through a network.

Interconnect 106 connects between request nodes and completer nodes of the data processing network. A request node (RN) may be Fully Coherent, I/O Coherent, or I/O Coherent with Distributed Virtual Memory (DVM) support. A Fully Coherent Request Node (RNF) contains coherent caches and will accept and respond to snoop messages. An I/O-Coherent Request Node (RNI) does not have a coherent cache, and cannot accept snoop messages. An I/O-Coherent Request Node with DVM support (RNI/D) has the same functionality as an RNI and can also accept DVM messages.

Data coherency and serialization is enabled by the use of home nodes coupled to or within the interconnect. A fully coherent home node serves as a home for range of system addresses, and writes to those address are routed to the associated home node. An input/output (I/O) Coherent home node (HNI) serves as a home node for writes targeting peripheral devices. When the home node is configured to couple to a PCIe device it may also be referred to as a HNP or HNI/P. The home node is responsible for ordering data received from the interconnect.

In one embodiment, request node 108 is an RNI/D that receives burst writes from PCIe controller 112. The writes are cracked into cacheline sized writes and transmitted across interconnect 106. If an HNP, such as HNP 120, is the target of those writes, it issues them to a bus interface 122, such as an Advanced Microcontroller Bus Architecture (AMBAR) Advanced extensible Interface (AXI), as separate 64-byte writes to PCIe controller 124. On downstream PCIe path 126 to endpoint 104, via PCIe network 128, link efficiency is reduced due to header overhead for each 64-byte transaction-layer packet (TLP). The gathering feature of the present disclosure improves the efficiency of this link by gathering the writes together at write gather circuitry 130 to enable a larger burst to be sent.

In accordance with embodiments of the disclosure, write gathering circuitry 130 is configured to gather cracked writes received from interconnect 106, so as to reconstruct the original burst at least partially. This can increase the capacity of the outbound path's downstream logic by reducing tracker resources required (i.e., having to track one burst rather than many cracked writes) or by optimizing the overhead of sending multiple requests (i.e., reducing PCIe header overhead). The outbound write gather circuitry 130 may see various streams from multiple sources concurrently. Embodiments of the disclosure support gathering cracked writes into a larger burst size and allow tracking and gathering multiple streams concurrently. Further, deadlocks, which could occur if there are more streams than gathering resources, are prevented through use of an eviction scheme.

Various embodiments below are described with respect to a PCIe bus with AXI, but it to be understood that other computer bus types and/or interface types may be used without departing from the present disclosure.

### Instructions for Automated Design and Fabrication

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

When fabricating a home node, the write gather circuitry is optional. The computer-readable code for fabrication of a home node that embodies the described concept may include a parameter (e.g., “HNP_WR_GATHER_PRESENT”) that enables building the logic for the write gather circuitry. The block itself may have a configurable number of gathering buffers defined by a further parameter (e.g., “HNP_WR_GATHER_NUM_BUF”), where each gathering buffer can independently gather streams of writes from different RNI/Ds, different ports of the RNI/Ds, and different write address identifiers (AWIDs) on each RNI/D's AXI interface. In one embodiment, the number of buffers can be set in a range 3-8, for example, although the code may specify any number of buffers to be fabricated. Less than three or more than 8 buffers may be fabricated without departing from the present disclosure. In one embodiment, the number of buffers is set to the number of unique RNI/D write streams plus two, for a good compromise between performance and chip area. The depth of the buffers may also be configurable in the fabrication code. For example, the depth could be 256 bytes or 512 bytes. This may be set in the fabrication code via another parameter (e.g., “HNP_WR_GATHER_BUF_SIZE”). This depth may be selected based on the typical Maximum Payload Size (MPS) settings of the PCIe controllers used. Setting the buffer depth to less than MPS may result in spillover from one buffer to the next, which would either require more buffers or result in reduced performance.

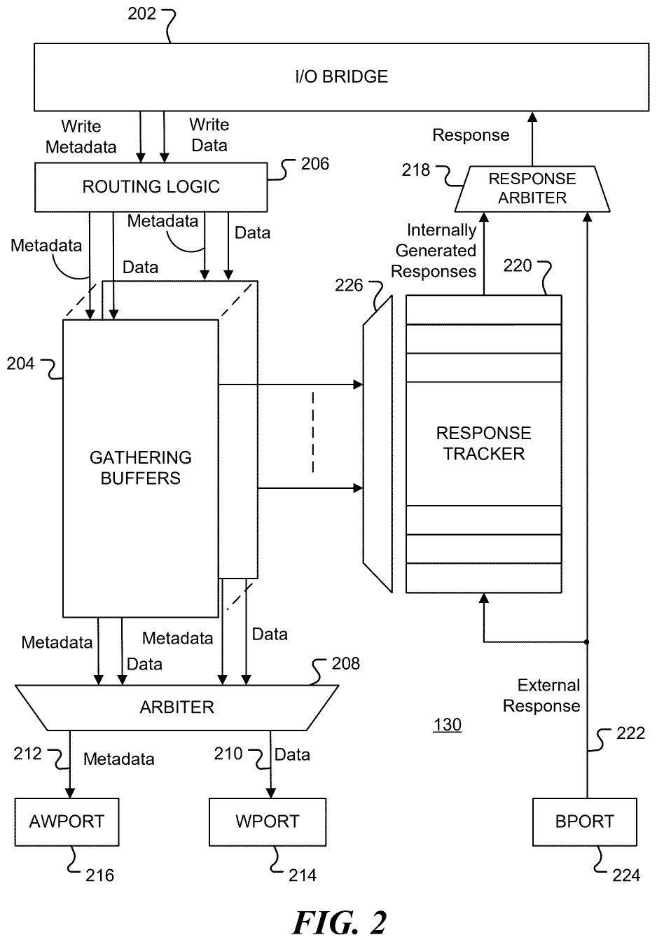

FIG. 2 is a block diagram of write gather circuitry of a data processing network, in accordance with various representative embodiments. Write gather circuitry 130 may be located at an I/O bridge 202 in the home node that provides internal interface of a peer-to-peer (P2P) write feature of the home node (such as an HNI/P). In one embodiment, the I/O bridge provides an AXI write slice. A write slice is a contiguous sequence of elements in a write burst rather than the whole burst. An AXI slice, for example, includes metadata associated with a write burst together with a slice of the write data itself.

Each slice includes, in the metadata, a stream identifier (SID) that indicates, for example, the source of the write burst and the associated port number. This enables cracked writes from the same stream to be gathered together. Write gather circuitry 130 includes a number of write gathering buffers 204 to enable multiple streams to be collected in parallel.

In one embodiment, each data stream is identified by the requesting RNI/D's Chip ID, logical ID, Advanced extensible Interface (AXI) port number, and hashed AWID (write address ID). An RNI/D may use a 4-bit hash to map the incoming AXI AWID to a 4-bit hashed value sent with the write over Coherent Hub Interface (CHI). This information is encoded in the stream identifier.

The metadata (including the stream identifier (SID)) and the write data are passed to routing logic 206. The write data is passed to the next available gathering buffer unless there is an SID match to an active buffer, in which case the new write and the write in the buffer are gathered in the active buffer. This continues until the last write of the stream is gathered, the buffer fills, or the buffer is evicted for re-use. The last cracked write of the stream is marked as such by the sending request node. The gathered burst is then sent out from the gathering buffer to the external AXI or other interface. If a write is not gatherable (e.g., a direct write to a device memory), it passes through a buffer, and then proceeds to the external interface once any ordering requirements are fulfilled.

### Write Arbiter

Write arbiter 208 multiplexes between gathered bursts from different gathering buffers. For an external link with parallel channels, data 210 and metadata 212 are sent to corresponding ports 214 and 216. Write arbiter 208 is used to arbitrate among buffers ready to send data and metadata to the external interface (such as AXI). In one embodiment, write arbiter 208 uses a Round Robin arbitration scheme, but other arbitration schemes may be used. In the case of an AXI implementation, write arbiter 208 may follow the same scheme as the other AXI arbiters in home node—managing the AW (metadata) and W (data) flow to ensure no accidental data interleaving.

### Response Arbiter

In some embodiments, the network protocol requires that responses, such as acknowledgements, be returned for cracked write requests. Response Arbiter 218 handles internally generated responses from response tracker 220 in addition to the external responses arriving from endpoints on link 222 via response port 224. For an AXI link, the response is a BRESP signal that indicates the status of a write transaction. A “round robin” arbitration scheme may be used, for example. Entries in response tracker 220 are generated by gathering buffers 204 and routed to a next available entry by selector 226.

### Port FIFOs

In one embodiment, the metadata (AW), data (W), and response (B) channel signals flow through port FIFOs that handle, for example, clock control and flow control.

### PCIe Restrictions

For PCIe endpoints, peer-to-peer (P2P) write gathering may impose some restrictions on the request node. For an RNI/D AXI manager, for example, these may include:
Only normal memory writes are gatherable. E.g., AWCACHE[1]=1′b1.
Only incremental (INCR) write bursts are supported. E.g., AWBURST-2′b01. FIXED and WRAP write bursts are not supported and may result in IMPLEMENTATION DEFINED behavior.
Only full write bursts are supported. Narrow write bursts are not supported and may result in IMPLEMENTATION DEFINED behavior.
   a. If AWLEN>0, AWSIZE must be AXI data width
   b. Misaligned start addresses are OK

In the above, AWLEN denotes the AXI burst length. The burst length gives the exact number of transfers in a burst. This information determines the number of data transfers associated with the address. AWSIZE denotes the burst size. This indicates the size of each transfer in the burst. In an incremental burst, the address for each transfer in the burst is an increment of the address for the previous transfer. The increment value depends on the size of the transfer. For example, the address for each transfer in a burst with a size of four bytes is the previous address plus four. This burst type is used for accesses to normal sequential memory, as opposed to cache memory, for example.

In addition, the appropriate RNI/D configuration bit (e.g., “cfg_ctl.pcie_mstr_present cfg”) must be set to indicate a PCIe RNI/D.

If the number of unique streams from all RNI/D sources is larger than the number of buffers present, an eviction scheme may be used to force a selected buffer to finish what is currently gathered and provide the gathered burst to the external interface, allowing the new write to use that buffer.

In one embodiment, the number of buffers is set to be two more than the number of RNI/D sources of Peer-to-Peer write bursts so as to hide the latency between the metadata (AW) and write data (W) channels internally to HNP and achieve full throughput. Therefore, as an example, if there are four RNI/Ds present that can issue Peer-to-Peer write bursts to HNP, the number of buffers is set to six.

In one embodiment, the depth or size of write gathering buffers 204 is set to the smaller of the expected maximum payload size (MPS) settings of the PCIe systems below RNI/D and HNP. In either case, there is an impact on HNP circuit area due, for example, to the implementation of these buffers in flip-flops when the HNP does not support SRAMs.

TABLE 1 lists some user-settable write gathering configuration parameters in accordance with various embodiments. These parameters may be present in Verilog code for fabrication home node, for example.

TABLE 1
Write gathering configuration parameters.

| Parameter | Values | Default | Description |
|---|---|---|---|
| HNP_WR_GATHER_PRESENT_PARAM | 0, 1 | 1 | If set, the write |
| | | | gathering logic is |
| | | | built into an I/O |
| | | | coherent Home Node |
| | | | optimized for PCIe |
| | | | (HN-P or HNP). |
| HNP_WR_GATHER_NUM_BUF_PARAM | 2-6 | 4 | Sets the number of |
| | For unit Val: | | write gathering |
| | 2-8 | | buffers to instantiate. |
| | | | Ideally this would be |
| | | | set to no less than the |
| | | | number of unique |
| | | | P2P write streams |
| | | | seen by HN-P. |
| HNP_WR_GATHER_BUF_SIZE_PARAM | 0 = 256 bytes, | 1 (512) | Determines the size |
| | 1 = 512 bytes | | of the write data |
| | For unit Val: | | buffer in bytes. This |
| | 0 = 256 bytes, | | should be set to no |
| | 1 = 512 bytes, | | more that the PCIe |
| | 2 = 1024 bytes, | | Maximum Payload |
| | 3 = 2048 bytes, | | Size (MPS). If MPS > |
| | 4 = 4096 bytes | | this parameter, then a |
| | | | gathered burst will be |
| | | | sent out when the |
| | | | buffer has filled. |

The user may select the parameters. Other parameters may be dependent on the write gathering configuration. For example, the HNP_WR_NUM_AXI_REQS_PARAM parameter is dependent on the write gathering configuration as follows:

$$RDT\_DEPTH >= ( NUM\_BUF \times ( ( BUF\_SIZE / 64 ) - 1 ) ) + 1 .$$

For example, the default config with NUM_BUF=4 and BUF_SIZE=512:

$$RDT\_DEPTH >= ( 4 \times ( ( 512 / 64 ) - 1 ) ) + 1 = ( 4 \times 7 ) + 1 = 29 .$$

The HNP_WR_NUM_AXI_REQS_PARAM default value is 32. Therefore, if BUF_SIZE is set to 512B, a NUM_BUF setting more than 4 requires

$$HNP\_WR \_NUM \_NUM \_REQS \_PARAM = 64.$$

In one embodiment, when the write gathering feature is present in the hardware of a data processing network, it may be disabled in software in by setting an associated bit in a control register. For example, this done by setting a “hnp_wr_gather_disable” bit in the configuration control register of HNP.

### Routing Logic

Routing logic 206 routes incoming data and metadata (such as metadata (AW) and data (W) flits) to a write gathering buffer 204. The stream identifier (SID) is used to identify which, if any, gathering buffer the stream is routed to. This may be done, for example, using a content addressable memory (CAM) in the routing logic or using the CAMs in any active gathering buffers. If there is a hit in the CAM, the data and metadata are routed to the corresponding buffer. If there is no hit, an inactive gathering buffer is allocated to the stream and the CAM is updated.

If an RNI/D with the same stream identifier sends back-to-back transactions where the first is the last of a previous burst and the second is a new burst or non-burst, the second transaction will be allocated to a new gathering buffer that is dependent upon the first for ordering. That second buffer should not issue to the external interface until the first has completely drained. Thus, there is an ordering relationship among gathering buffers for such cases.

In one embodiment, routing logic 206 tracks the relationship between the streams and the data. When a new stream identifier arrives, the buffer number it is routed to is pushed into a first-in-first-out (FIFO) buffer. Subsequent data is routed to that buffer until the last cracked write is received. The FIFO buffer is the popped ready for the next sequence of data.

### Response Tracker

As described above, in embodiments where the network protocol requires response to write transaction, Response Tracker 220 is used to manage response ordering for writes with the same stream identifier. It is also responsible for generating sending early internal responses back to the home node. For example, for an AXI eternal interface, when a gathering buffer is ready to send out the AW and W signals to AXI, it allocates the next free response tracker entry via selector 226, providing the number of early responses to send and the associated identifier. This number is one less than the number of writes gathered, since the final response needs to come from external AXI. A buffer with greater depth can support a larger external response latency (from the sending of the last data beat or packet to receipt of the response). For example, a response tracker configured to be 32 entries deep can support a maximum latency of 128 Coherent Mesh Network (CMN) clocks. Tracker entries with the same stream identifier maintain order. Tracker entries with different stream identifiers are unordered.

As soon as an ordering hazard clears, the entry will send early internal responses to response arbiter 218 and wait for the final external response 222 to arrive from response port 224. When this is observed, the entry deallocates as the response proceeds to response arbiter, thus clearing the hazard for the next dependent entry with the same stream identifier.

### Gathering Buffers

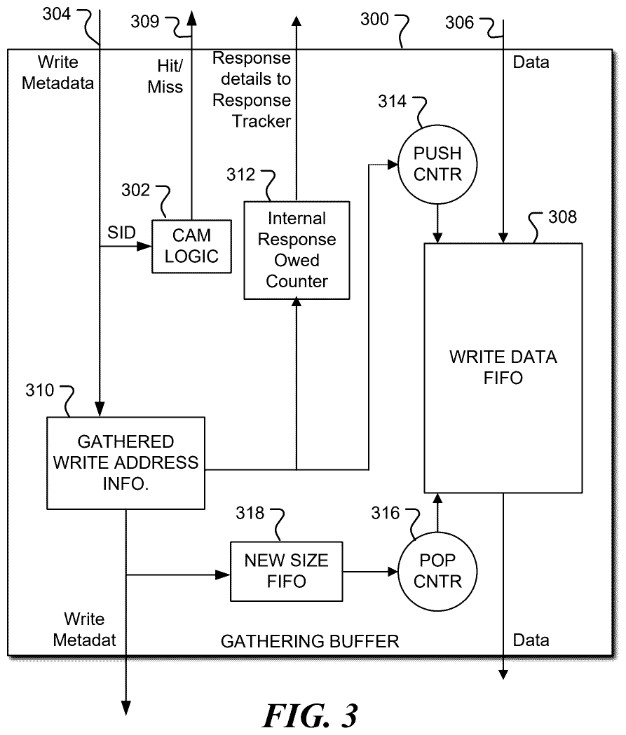

FIG. 3 is a block diagram of a write gathering buffer 300, in accordance with various embodiments. The number of write gathering buffers is chosen via the HNP_WR_GATHER_NUM_BUF_PARAM parameter. The data storage depth of each is chosen via the HNP_WR_GATHER_BUF_SIZE_PARAM parameter, which is measured in bytes. If the buffer is in use, gathering buffer 300 includes CAM 302 that stores the stream identifier of the stream allocated to the gathering buffer. When a new write is received at the write gather circuitry, the routing logic accesses the CAM using the stream identifier in write metadata 304. If there is a hit, the new data 306 are routed to write data FIFO buffer 308 of the gathering buffer. When a gathering buffer is allocated on a new arrival, the data are stored and the buffer is marked as busy. Subsequent arrivals routed to this same buffer cause the length field in gathered write information store 310 to increment. For example, the length of the arriving data is added to the current length plus 1). Arrivals, other than the first arrival, also generate early internal response flits back to home node by incrementing counter 312. Push counter 314 is loaded with the arriving write length and is used count arriving data beats pushed into write data FIFO buffer 308. The data in the gathering buffer are marked as “ready to send” when: a) the “Last” indicator was seen on write metadata and the last beat of the write data was received, or b) the arriving data and metadata caused the data buffer to fill to maximum capacity. When the buffer is ready to send, it requests to flow through the write arbiter of the write gather circuitry. When the metadata and corresponding gathered write data have drained, the gathering buffer is deallocated for re-use. As the data is draining, the “Last” indicator is updated to mark the new last beat using data pop counter 316 and updated length field 318.

When the “disable” bit is set, no gathering occurs. All incoming data and metadata flits are immediately routed through the buffer.

### CHI to AXI AWID Assignment

Gathering may only be allowed for writes with the same stream identifier (SID). In one embodiment, the SID is encoded to reflect the source RNI/D, the source port of that RNI/D, and the source AWID on that port. In an embodiment that uses a CHI interconnect, this information is provided over the interconnect to the home node as follows:

TABLE 2
Stream Identifier Information.

| | | |
|---|---|---|
| P2P Hint | PCIe Peer-to-Peer write hint | Writes marked with the PCIe Peer-to-Peer |
| | | hint may be gathered. Otherwise, the |
| | | writes are not to be gathered. |
| Chip ID | CHI REQ.ReturnTxnID[7:6] | RNI/D indicates the ID of the chip it is |
| | | present on via the ReturnTxnID. The Chip |
| | | ID value is programmed into RNI/D's |
| | | config registers. |
| PCIe | CHI REQ.SrcType | Set if the SrcType indicates a PCIe RNI or |
| RNI/D | | RND |
| indicator | | |
| RNI vs. | CHI REQ.SrcType | Set if the SrcType indicates a PCIe RNI, |
| RND | | clear if a PCIe RND |
| indicator | | |
| Logical | CHI REQ.ReturnNID[6:0] | On each chip, RNIs and RNDs are given |
| RNI/D ID | | logical IDs (LDIDs) to uniquify them. |
| | | RNIs and RNDs have separate LDID |
| | | spaces, so a chip can have RNI LDID = 0 |
| | | and RND LDID = 0. The SrcType above |
| | | distinguishes between them. |
| RNI/D | CHI REQ.ReturnTxnID[5:4] | Indicates which of the three AXI ports of |
| Port | | the RNI/D. |
| Number | | |
| RNI/D | CHI REQ.ReturnTxnID[3:0] | The original AWID of the write burst on |
| Hashed | | the RNI/D is hashed into a 4-bit value |
| AWID | | provided here. PCIe systems typically use |
| | | AWID = 0 to ensure strong write ordering. |

Some or all of the information may be encoded in the stream identifier (SID). Additionally, an RNI/D will indicate when a cracked write is the last write of a burst. For example, signal REQ.TxnID[8] is set to one when the write was a burst and this cracked write is not the last of the burst. On the last crack of the write, this bit will be zero. This information is then converted to the “last” indicator and driven on AXI AWUSER[MSB]. For example, if a 256B write is received by a PCIe RNI, it will send 4 64B writes to HNP. The first three writes will have TxnID[8]=1, the last write will have TxnID[8]=0. When the writes are not gathered (i.e., when the write gathering feature is disabled or not present), the first three writes on HNP's AXI will have AWUSER[MSB]=0 and the last write will have AWUSER[MSB]=1.

### Incoming Write Hazarding and Ordering

Hazarding and Ordering is used in the gathering buffers to maintain the original peer-to-peer write slice ordering through the gathering buffers out to the external interface, such as an AXI. When a buffer is allocated, if the associated stream has an ordering relationship to another active buffer, that buffer number will be stored. An ordering hazard is detected as follows. When a new write arrives for a new gatherable or non-gatherable stream, the stream identifier is used to query the CAMs in the active buffers. If an active buffer has received the “Last” indicator (the indicator from RNI/D that this write is the last in the burst) or has forced itself to be done either due to an eviction or not having enough space to take in the new write, it will respond with an ordering hazard flag. This causes the new buffer to store that buffer number as a parent buffer. The new buffer becomes the child buffer. When the parent buffer sends the last data beat to external interface, the child buffer will see that event and clear the dependency flag to allow forward progress to issue to the external interface.

### Response Hazarding and Ordering

Response hazarding and ordering is used in the response tracker to ensure that responses sent back to the HNP P2P I/O bridge maintain proper order. This prevents a buffer gathering a new stream from sending early internal responses ahead of a previous buffer with matching stream identifier that sent a “Last” RNI/D write to the external interface and is awaiting an external response.

### Evictions for Deadlock Avoidance

If the number of unique streams arriving at the write gather circuitry exceeds the total number of buffers, a deadlock can occur. For example, if there are four buffers, each busy gathering bursts for four different streams, and a new write for a fifth stream arrives, the write has nowhere to go so it stalls. This in turn blocks the subsequent writes needed for the busy gathering buffers to make progress. To avoid this, an eviction scheme is used. When a new write arrives when all buffers are full and there is no CAM match with any of them, one of the active buffers will be chosen for eviction, making room for the new write. In one embodiment, the eviction scheme may use a round robin arbiter to attempt to choose victim buffers in a fair manner.

### CHI Write Data Cancel

In an embodiment that uses a CHI interconnect, an RNI/D can mark tunneled write data with the Write Data Cancel DAT opcode as a way to “undo” the write due to a potential hang condition detected. The HNP could either internally terminate these writes or pass them to AXI for completion. The write cannot be gathered so the HNP P2P write slice can mark these writes using an unused field in the metadata such as the AWNSAID field (bit 0), before they are passed to the gathering block so the gathering block knows that the writes are Write Data Cancel (WDC) writes. The gathering buffers will not allow gathering on these writes. New allocates with WDC writes will be marked as “Last” immediately and sent out. Active buffers still gathering will not gather a new write marked as WDC. The new write will be routed to and allocated into a new buffer.

### Done/New Buffer Cases

There are three conditions that will mark a gathering buffer as “done” so it will proceed to the external interface. The arriving write will not be gathered but will instead use a new buffer. The condition include the following:
1. An eviction (no stream identifier matches found). This can happen if there are more unique write streams than gathering buffers.
2. The size of the write more than fills the remaining buffer size. This can happen if the RNI/D burst started on a misaligned address.
3. A write that was completed by RNI/D with a Write Data Cancel DAT opcode.

### Write Metadata Contents

In one embodiment, where the external interface is an AXI, the metadata is represented in AW signals. The contents of the AW sent out from the gathering block follow these example rules:
The AWUSER value sent out on a potentially gathered burst will contain the most recently received AWUSER value from HNP. Only the AW containing the last write in a cracked burst from RNI/D will have AWUSER [MSB] set to indicate the last of the burst. All other AWs sent out will have this bit cleared. This allows a downstream write gather circuitry to gather even further than this block if desired. For example, if a 512B burst from RNI/D arrives and the gathering buffer depth is 256B, the first 256B will gather and fill the first buffer, causing it to send out to AXI when full. This burst will not have AWUSER [MSB] set. The second 256B will gather and fill the second buffer, causing it to send out when full. Since this burst contains the last from RNI/D, AWUSER [MSB] will be set.
The AWLEN value sent out will reflect the new size of the gathered burst.
The AWSIZE value will be set to the width of the HNP AXI data bus.
The AWBURST value will be set to INCR if any gathering occurred, otherwise it will contain the original AWBURST value from HNP.
The AWNSAID bit, used internally to signal WDC writes, will be set back to 0 since it is not used for HNP writes.
All other fields on AW will contain the values from the first AW received from HNP for the RNI write stream.

### Data Contents

In one embodiment, where the external interface is an AXI and the interconnect is CHI, The contents of the data (W) fields sent out follow these example rules:
The WLAST indicator will be updated to reflect the last data of the gathered burst. This may not match the last indicated by RNI over CHI due to the following cases: a) the gathering buffer reaches full, b) the buffer gets evicted to avoid deadlock, or c) the lower 12 address bits do not match the expected next address to gather.
All other fields on W will contain the same values for each W received from HNP for the RNI write stream.

### TraceTag

Since the gathering logic gathers separate small writes into a larger burst before sending out on AXI, support for “TraceTag” cannot be honored accurately. A TraceTag may be a one-bit field added to some or all channels to aid debugging and profiling. The RTL behavior is as follows:
Each gathered AW will keep the most recent AWTRACEM value seen from HNP before the burst is sent out. For example, if four cachelines are gathered and the buffer becomes full before seeing the RNI/D last, the AWTRACEM value of the fourth cacheline will be used when sending the gathered AW.
Each gathered W will maintain the WTRACE received from HNP. This means that the WTRACE values should match those when gathering is not enabled.

This scheme ensures that the write from RNI/D that was marked last will have the TraceTag value preserved from end to end.

### Error Cases

For gathered data responses any to non-last writes from RNI/D will get an internally generated response, such as a completion or “Comp” response on the CHI from the HNP. No error will be signaled on these responses. However, if an error is present on the subsequent responses for these writes, they will be logged as a Reliability, Availability, and Serviceability (RAS) error in the response since the Comp response has already been given. With this feature, any gathered writes that issue before the RNI/D last write (i.e., a large burst caused a gathering buffer to fill and be sent out before receiving last from RNI/D or an eviction occurs) may receive an error from the AXI subordinate that will cause this same RAS error.

The final last write from RNI/D will be expected to get an external from the AXI subordinate, so that error will pass back to RNI/D via the response (such as the CHI Comp). No RAS error will be logged for this case. This remains the same with the gathering feature. As mentioned below, this could be used as a mechanism to verify that the final response always comes from the AXI subordinate (target endpoint) rather than from a response generated internally by the write gather circuitry.

While a coherent interconnect of Arm's Advanced Microcontroller Bus Architectures (AMBAR) CHI and AXI has been described, it is envisioned that the improvements discussed herein are not so limited.

### Routing Logic.

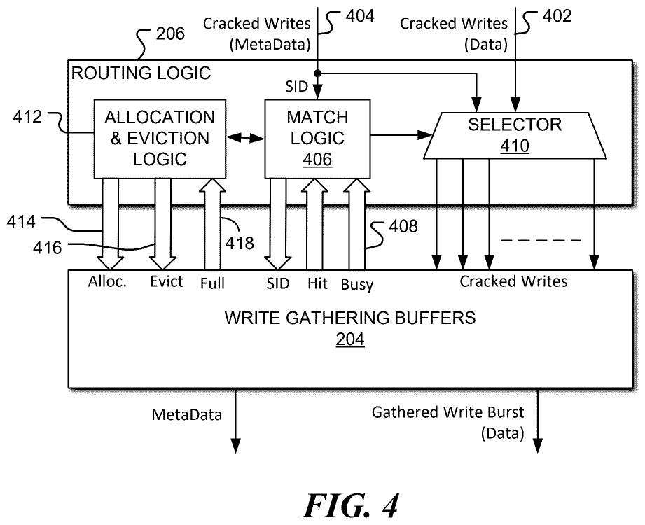

FIG. 4 is a block diagram of a routing logic block 206 showing connections to write gathering buffers 204, in accordance with various representative embodiments. Routing logic 206 receives cracked write data 402 and cracked write metadata 404 from an I/O bridge of a home node. Cracked write metadata 404 includes stream identifier (SID) signal that is passed to match logic circuitry 406. Match logic circuitry 406 passes the SID to those write gathering buffers that are currently gathering stream data (as indicated by “busy” signals 408). The gathering buffers index their CAMs and each indicates in “Hit” signals whether the SID hit or missed in the CAM. If a gathering buffer indicates a hit, the match logic controls selector 410 to route the write data and metadata to the identified gathering buffer.

If no hit is indicated by any gathering buffer, allocation and eviction logic circuitry 412 selects an inactive gathering buffer and allocates it the stream and signal the buffer in signal 414. The data and metadata are then routed to this buffer.

If no hit is indicated by any gathering buffer and all buffers are busy, allocation and eviction logic circuitry 412 selects an active gathering buffer and signals it to evict the gathered writes using signal 416. The buffer is then allocated for the new stream and the data and metadata are then routed to this buffer.

If a gathering buffer becomes filled, as indicated by “Full” signal 418. Allocation and eviction logic circuitry 412 allocates an idle gathering buffer as a “spillover” buffer. The allocated buffer is a child buffer of the filled buffer and the child buffer indicates that the filled buffer is a parent buffer and must be drained before the child buffer is drained so as to maintain the order of writes.

### Response Tracker

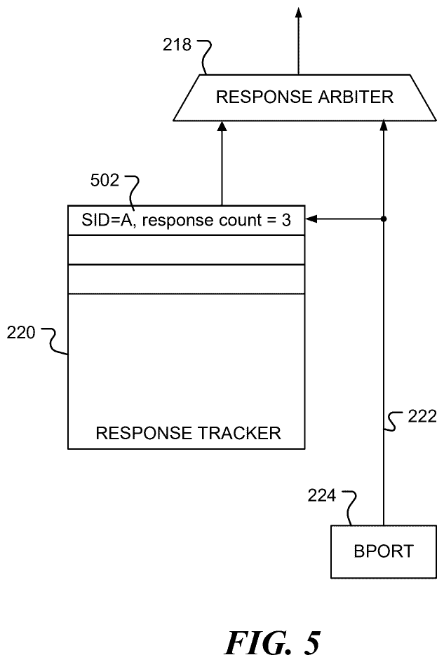

FIG. 5 is a block diagram of a response tracker 220, in accordance with various representative embodiments. Response tracker 220 includes a table for storing a number of entries. The number of entries may be greater that the number of write gathering buffers. For example, the table may store up to 32 entries. Each entry is generated when a gathered write burst is transmitted from the write gather circuitry to the external interface. In the example shown, the table includes single entry 502. Entry 502 indicates that a burst with stream identifier SID has been sent and that three internally generated responses should be sent to response arbiter 218. The burst contained four cracked writes. The external response to the fourth and last write is received on line 222 from response port 224. The tracker table entry may be deallocated for re-use once the external response has been sent.

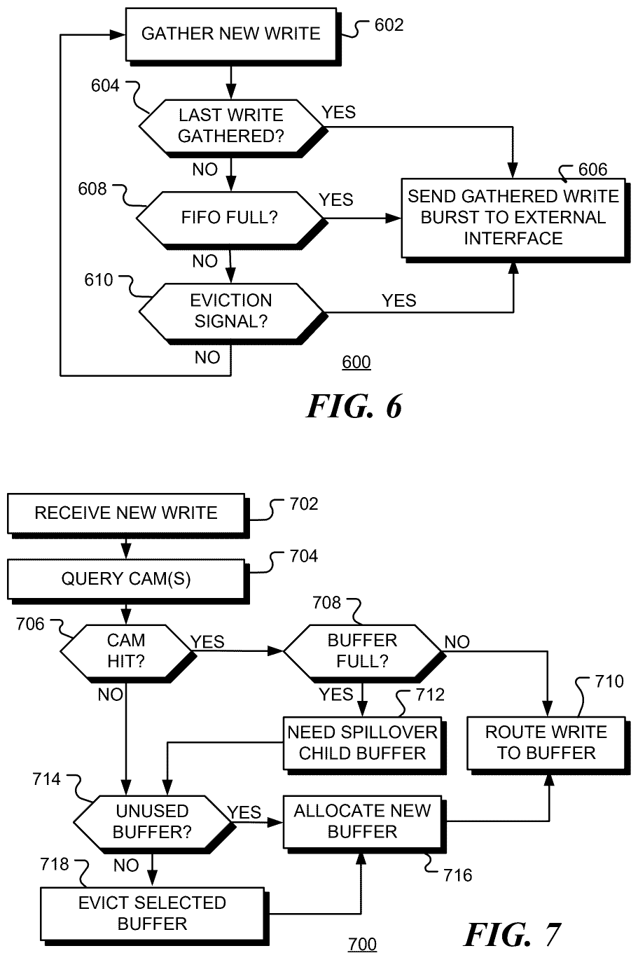

FIG. 6 is a flow chart 600 of a method of write gathering in a data processing network, in accordance with various representative embodiments. A new cracked write for a stream is gathered at the write gather circuitry at block 602. When the cracked write is the last write of a cracked write burst, as indicated by the positive branch from decision block 604, the gathered writes are sent to an external interface at block 606. Otherwise, when the FIFO buffer of the gathering buffer is full, as indicated by the positive branch from decision block 608, the gathered writes are sent to an external interface at block 606. Otherwise, when an eviction signal received at the write gathering buffer, as indicated by the positive branch from decision block 610, the gathered writes are sent to an external interface at block 606.

Thus, the cracked writes are gathered in accordance with a stream identifier until the last write of a stream is gathered, the write gathering buffer fills, or the write gathering buffer is evicted for re-use.

FIG. 7 is a flow chart 700 of a method of routing cracked writes in a write gather circuitry of a data processing network, in accordance with various representative embodiments. At block 702, a new cracked write is received at a routing logic block of a write gather circuitry. The cracked write includes write data and corresponding metadata, including a stream identifier. At block 704 the CAMs of any busy write gathering buffers are queried to identify any write gathering buffer of the one or more write gathering buffers that is currently allocated to the stream identifier. In a further embodiment, all write gathering buffers are queried. In a still further embodiment, a CAM in the routing logic block is queried. If there is a hit in the CAM of a write gathering buffer, as indicated by the positive branch from decision block 706, flow continues to decision block 708. If the write gathering buffer is not full, as indicated by the negative branch from decision block 708, the cracked write is routed to the identified buffer at block 710. When the write gathering buffer is full, as indicated by the positive branch from decision block 708, a spillover buffer is needed, as indicated by block 712.

When there is no hit from any write gathering buffer, as indicated by the negative branch from decision block 706, or a spillover buffer is needed, flow continues to decision block 714. When there are one or more unused write gathering buffers, as indicated by the positive branch from decision block 714, an unused buffer is selected and allocated for the stream at block 716 and the write is routed to the newly allocated write gathering buffer at block 710.

If there is no hit from any write gathering buffer and there are no unused gathering buffers, as indicated by the negative branch from decision block 714, an in-use write gathering buffer is selected and the gathered write data is evicted at block 718. The selected write gathering buffer is allocated for the stream at block 716 and the write is routed to the newly allocated write gathering buffer at block 710.

### Gathering Example: 256 Byte Burst from an RNI

By way of example, the gathering of a 256 byte write burst is described. The 256B write burst may be from a PCI or PCIe endpoint, for example, and is received at an I/O-coherent Request Node (RNI). The RNI cracks the write burst into four 64B writes and sends them over a Coherent Hub Interface (CHI) to an I/O coherent Home Node (HNI). The cracked writes denoted A0, A1, A2, A3, where A indicates a stream identifier (SID) for this source. The labels enable write the gathering block to determine that these writes can be gathered. A different stream would have a different stream identifier. Since the last of the writes is A3, A3 will have a marker attached to indicate this is the last write of the burst.

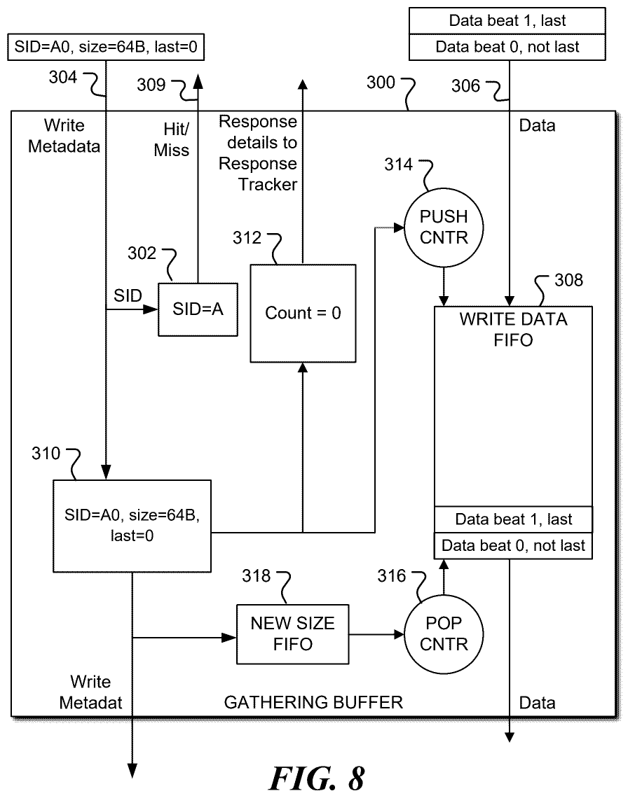

Step 1: FIG. 8 shows arrival of the first write, A0, at a write gathering buffer of an HNI. The write metadata at 304 includes SID=A, size=64B, last=False. For this example, the HNI has an AXI data bus with the bus width assumed to be 256 bits (32B). There will be two “beats” of write data associated with A0 at input 306. The internal response count 312 remains at zero since if this write is evicted the response will come from the downstream target or endpoint. The stream identifier is stored in CAM 310 and the data is gathered in write data buffer 308. Metadata 310 is initialized.

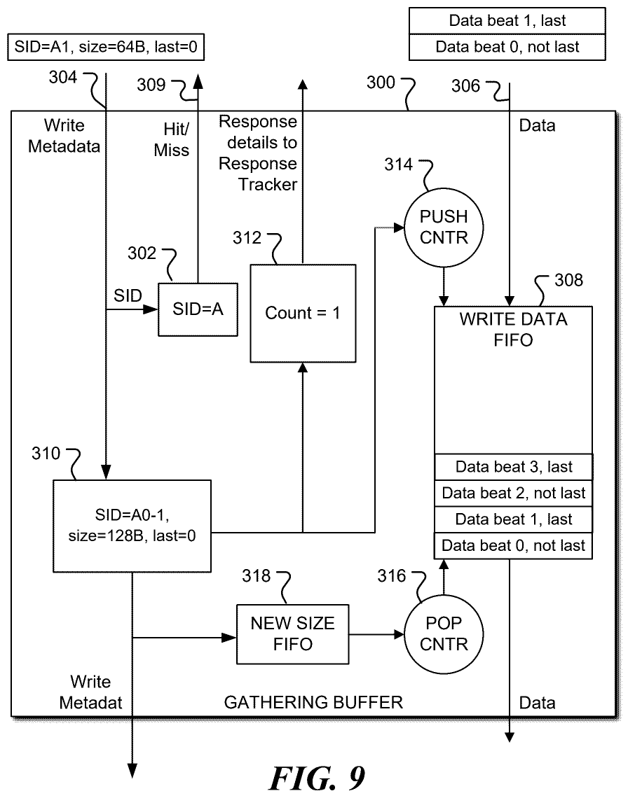

Step 2: FIG. 9 shows arrival of the next cracked write, A1, with stream identifier SID=A. This matches the active buffer, so this write is gathered. Now that two writes have been gathered, the internal response owed count 312 increments to one. A single internal response (e.g., BRESP) will be given and one external response will be received later. Metadata 310 is updated and the data is gathered in write data buffer 308. In the embodiment shown, data in write data FIFO 308 retains the “last” markings of the received bytes. However, the markings will be rewritten when the FIFO is drained.

Step 3: The next cracked write, A2, arrives. SID=A, which matches the active buffer, so this write is gathered. Now that three writes have been gathered, the internal response owed count increments to two.

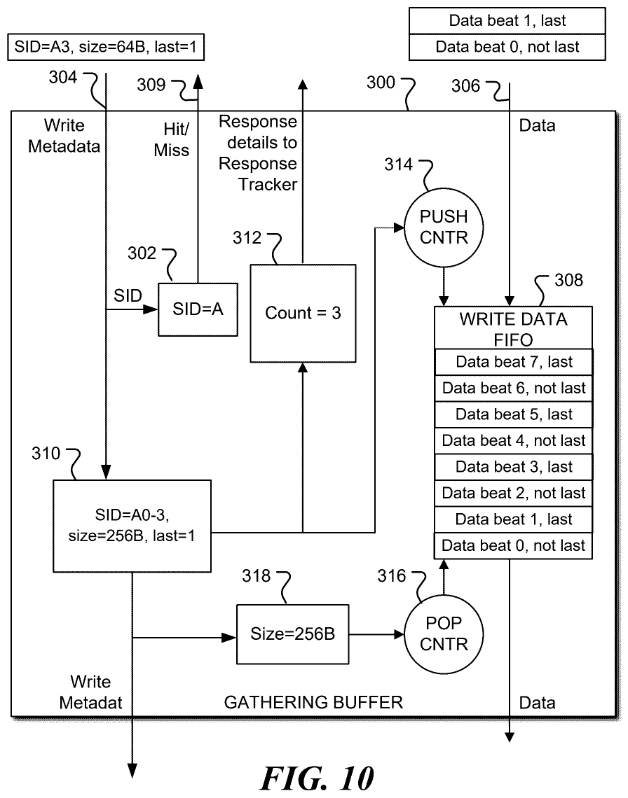

Step 4: FIG. 10 shows arrival of the last cracked write, A3. A3 was marked by RNI as “last”, so this is the final write to be gathered. The response owed count 312 increments to three. Metadata 310 is updated and the data is gathered in write data buffer 308. The FIFO size 318 is updated to 256B.

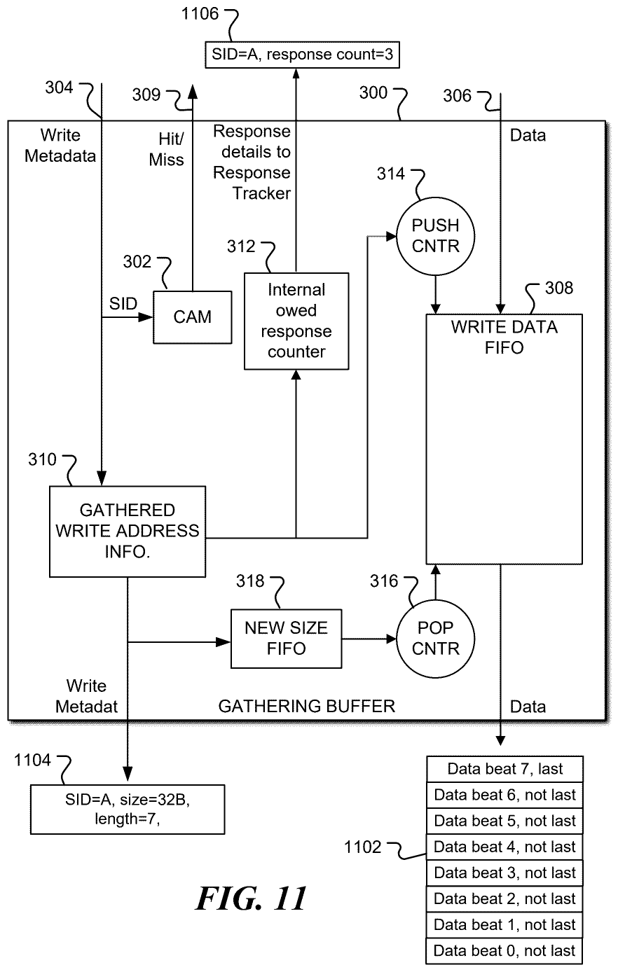

Step 5: FIG. 11 shows output of the gathered writes to external AXI as gathered write burst including data 1102 and metadata 1104. Associated response information 1106, which includes the owed response count, is signaled for allocation into an entry of the response tracker. The response tracker sends three internal responses, then waits for external response to arrive before deallocating the entry. While active, the response tracker prevents younger writes with same SID from issuing internal responses so as to maintain proper response order for same stream writes. When the gathering is complete, as the data is popped from FIFO 308, POP CNTR logic 316 rewrites the “last” indicator such that the new last beat (data beat 7) is marked as “last”. All previous beats are rewritten as “not last”. Thus, the POP CNTR logic is configured to set the “last” indicator as the data is pulled out of the FIFO.

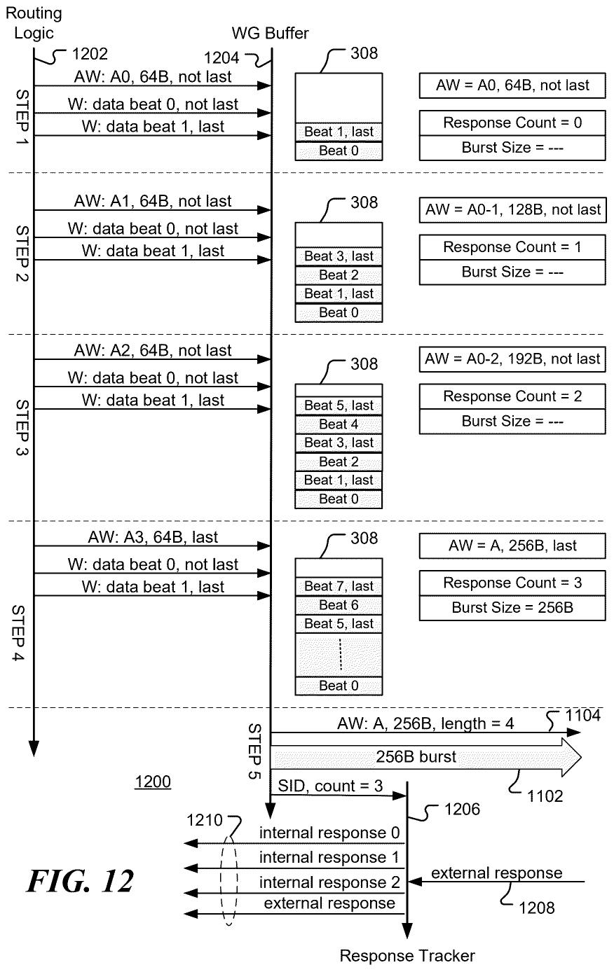

FIG. 12 is an interaction chart 1200 for the example gathering operation described above. FIG. 12 shows timeline 1202 for routing logic of the write gather circuitry, timeline 1204 for a write gathering buffer of the write gather circuitry, and timeline 1206 for the response tracker of the write gather circuitry. Time flows in the downward direction. Metadata (AW) and write data (W) is routed to the write gathering buffer where it is gathering in write data FIFO 308. External response 1208 is received from the target or endpoint. The response tracker sends responses 1210 back to the I/O bridge, which include three generated internal responses and the external response.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

As described above, an embodiment of the disclosure provides a method of gathering writes in a data processing network. The method includes, at write gather circuitry of the data processing network, gathering, in a write gathering buffer of one or more write gathering buffers of the write gather circuitry, one or more cracked writes from one or more streams transmitted across an interconnect of the data processing network in accordance with a stream identifier until the last write of a stream is gathered, the write gathering buffer fills, or the write gathering buffer is evicted for re-use. The gathered one or more cracked writes data are transmitted in a gathered write burst to an external interface of the data processing network.

The write of the gathered write burst to be transmitted last may be marked as a last write of the gathered write burst.

In one embodiment, the method includes sending, from the write gather circuitry, a response to the interconnect for cracked write of the gathered write burst except for a last cracked write of the transmitted gathered write burst, and forwarding to the interconnect a response received at the external interface subsequent to transmitting the gathered write burst.

The one or more cracked writes may be generated from an external data burst. In which case the method may include marking the write gathering buffer as a child buffer when a parent write gathering buffer contains one or more cracked writes generated from a previous external data burst and having the same stream identifier. Prior to transmitting gathered write burst from the child write gathering buffer, a gathered write burst is transmitted from the parent write gathering buffer.

Transmission of the gathered write burst from the external interface to an endpoint of the data processing network, may include transmitting the gathered write burst over a point-to-point link.

In one embodiment, the method includes a routing logic block of the write gather circuitry receiving write data and a stream identifier of a cracked write, identifying any write gathering buffer of the one or more write gathering buffers that is allocated to the stream identifier, identifying an unused write gathering buffer of the one or more write gathering buffers to the stream identifier of the cracked write when no write gathering buffer of the one or more write gathering buffers is allocated to the stream identifier and allocating the unused buffer to the stream identifier, and routing the write to the allocated write gathering buffer.

In one embodiment, the method includes, at the routing logic block when the write gathering buffer allocated to the stream identifier is full: allocating a new write gathering buffer to the stream identifier, and marking the new write gathering buffer as a child write gathering buffer of the full write gathering buffer.

In one embodiment, the method includes, at the routing logic block when no write gathering buffer of the one or more write gathering buffers is allocated to the stream identifier and there are no unused write gathering buffers: selecting a used write gathering buffer, and signaling the selected used write gathering buffer to evict the gathered one or more cracked writes.

In one embodiment, the method includes transmitting the gathered write burst to a first endpoint of the data processing network where said transmitting include transmitting in accordance with a packetized protocol. The one or more cracked writes may be generated from a write burst received at a request node of the data processing network.

In accordance with various embodiments, write gather circuitry for a data processing network is configured to receive cracked writes transmitted across an interconnect of the data processing network from one or more data streams, each data stream associated with a stream identifier, the write gather circuitry including one or more write gathering buffers. A write gathering buffer of the one or more write gathering buffers is configured to gather one or more cracked writes, received at the write gather circuitry, in accordance with a stream identifier until the last write of a stream is gathered, the write gathering buffer fills, or the write gathering buffer is evicted for re-use. The gathered one or more cracked writes are transmitted in a gathered write burst to an external interface of the data processing network.

In one embodiment, the write gather circuitry is configured to send a response to the interconnect for each portion of write data of the gathered write burst except for the last cracked write of the transmitted gathered write burst, and forward, to the interconnect, a response received at the external interface subsequent to transmitting the gathered write burst. The cracked writes may be generated from an external data burst, where the write gather circuitry is further configured to mark the write gathering buffer as a child buffer when a parent write gathering buffer contains one or more cracked writes generated from a previous external data burst and having the same stream identifier. Prior to transmitting the gathered write burst from the child write gathering buffer, a gathered write burst from the parent write gathering buffer is transmitted.

The external interface may be an interface to a point-to-point link.

In one embodiment, the write gather circuitry includes a routing logic block configured to receive write data and a stream identifier of a cracked write, identify any write gathering buffer of the one or more write gathering buffers that is allocated to the stream identifier, identify an unused write gathering buffer of the one or more write gathering buffers to the stream identifier of the cracked write when no write gathering buffer of the one or more write gathering buffers is allocated to the stream identifier and allocate the unused buffer to the stream identifier, and route the cracked write to the allocated write gathering buffer.

In one embodiment, the routing logic block is configured to, when no write gathering buffer of the one or more write gathering buffers is allocated to the stream identifier and there are no unused write gathering buffers: select a used write gathering buffer, and signal the selected used write gathering buffer to evict the gathered one or more cracked writes.

The gathered write burst may be transmitted to a Peripheral Component Interconnect Express (PCIe) controller coupled to the write gather circuitry.

In various embodiments, a non-transitory computer-readable medium stores computer-readable code for fabrication of a write gather circuitry of data processing network. The write gather circuitry is configured to receive cracked writes transmitted across an interconnect of the data processing network from one or more data streams, each data stream associated with a stream identifier. A write gathering buffer is configured to gather one or more cracked writes received at the write gather circuitry in accordance with a stream identifier until the last write of a stream is gathered, the write gathering buffer fills, or the write gathering buffer is evicted for re-use, The gathered one or more cracked writes are transmitted in a gathered write burst to an external interface of the data processing network.

The computer-readable code may designate a number of the one or more write gathering buffers in the write gather circuitry and the number is based on the number of unique write steams across the interconnect.

The computer-readable code may designate a depth of each of the one or more write gathering buffers of the write gather circuitry and the depth of each of the one or more write gathering buffers is based on the maximum payload size settings of a controller of the data processing network.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method of gathering writes in a data processing network, comprising:
at write gather circuitry of the data processing network:
gathering, in a write gathering buffer of one or more write gathering buffers of the write gather circuitry, one or more cracked writes from one or more streams transmitted across an interconnect of the data processing network in accordance with a stream identifier until occurrence of one or more of:
the last write of a stream is gathered,
the write gathering buffer fills, or
the write gathering buffer is evicted for re-use; and
transmitting the gathered one or more cracked writes in a gathered write burst to an external interface of the data processing network.

2. The method of claim 1, further comprising labeling the write of the gathered write burst to be transmitted last as a last write of the gathered write burst.

3. The method of claim 1, where the transmitted gathered write burst includes a plurality of cracked writes, the method further comprising:
sending, from the write gather circuitry, a response to the interconnect for each cracked write of the gathered write burst except for a last cracked write of the transmitted gathered write burst; and
forwarding to the interconnect a response received at the external interface subsequent to transmitting the gathered write burst.

4. The method of claim 1, where the one or more cracked writes are generated from an external data burst, the method further comprising:
marking the write gathering buffer as a child buffer when a parent write gathering buffer contains one or more cracked writes generated from a previous external data burst and having the same stream identifier; and
prior to transmitting gathered write burst from the child write gathering buffer:
transmitting a gathered write burst from the parent write gathering buffer.

5. The method of claim 4, further comprising transmitting the gathered write burst from the external interface to an endpoint of the data processing network, including transmitting the gathered write burst over a point-to-point link.

6. The method of claim 1, further comprising, at a routing logic block of the write gather circuitry:
receiving write data and a stream identifier of a cracked write;
identifying any write gathering buffer of the one or more write gathering buffers that is allocated to the stream identifier;
identifying an unused write gathering buffer of the one or more write gathering buffers to the stream identifier of the cracked write when no write gathering buffer of the one or more write gathering buffers is allocated to the stream identifier and allocating the unused buffer to the stream identifier; and
routing the write to the allocated write gathering buffer.

7. The method of claim 6, further comprising, at the routing logic block:
when the write gathering buffer allocated to the stream identifier is full:
allocating a new write gathering buffer to the stream identifier; and
marking the new write gathering buffer as a child write gathering buffer of the full write gathering buffer.

8. The method of claim 6, further comprising, at the routing logic block:
when no write gathering buffer of the one or more write gathering buffers is allocated to the stream identifier and there are no unused write gathering buffers:
selecting a used write gathering buffer; and
signaling the selected used write gathering buffer to evict the gathered one or more cracked writes.

9. The method of claim 1, further comprising transmitting the gathered write burst to a first endpoint of the data processing network where said transmitting include transmitting in accordance with a packetized protocol.

10. The method of claim 9, further comprising generating the one or more cracked writes from a write burst received at a request node of the data processing network.

11. A write gather circuitry for a data processing network comprising:
one or more write gathering buffers;
where the write gather circuitry is configured to receive cracked writes transmitted across an interconnect of the data processing network from one or more data streams, each data stream associated with a stream identifier, and
where a write gathering buffer of the one or more write gathering buffers is configured to:
gather one or more cracked writes, received at the write gather circuitry, in accordance with a stream identifier until occurrence of one or more of:
the last write of a stream is gathered,
the write gathering buffer fills, or
the write gathering buffer is evicted for re-use; and
transmit the gathered one or more cracked writes in a gathered write burst to an external interface of the data processing network.

12. The write gather circuitry of claim 11, further configured to:
send a response to the interconnect for each cracked write of the gathered write burst except for the last cracked write of the transmitted gathered write burst; and
forward, to the interconnect, a response received at the external interface subsequent to transmitting the gathered write burst.

13. The write gather circuitry of claim 11, where the cracked writes are generated from an external data burst, where the write gather circuitry is further configured to:
mark the write gathering buffer as a child buffer when a parent write gathering buffer contains one or more cracked writes generated from a previous external data burst and having the same stream identifier; and
prior to transmitting gathered write burst from the child write gathering buffer:
transmit a gathered write burst from the parent write gathering buffer.

14. The write gather circuitry of claim 11, where the external interface is an interface to a point-to-point link.

15. The write gather circuitry of claim 11, where the write gather circuitry includes a routing logic block configured to:
receive write data and a stream identifier of a cracked write;
identify any write gathering buffer of the one or more write gathering buffers that is allocated to the stream identifier;
identify an unused write gathering buffer of the one or more write gathering buffers to the stream identifier of the cracked write when no write gathering buffer of the one or more write gathering buffers is allocated to the stream identifier and allocate the unused buffer to the stream identifier; and
route the write data to the allocated write gathering buffer.

16. The write gather circuitry of claim 15, where the routing logic block is further configured to:
when no write gathering buffer of the one or more write gathering buffers is allocated to the stream identifier and there are no unused write gathering buffers:
select a used write gathering buffer; and
signal the selected used write gathering buffer to evict the gathered one or more cracked writes.

17. The write gather circuitry of claim 11, further configured to transmit the gathered write burst to a Peripheral Component Interconnect Express (PCIe) controller coupled to the write gather circuitry.

18. A non-transitory computer-readable medium storing computer-readable code for fabrication of a write gather circuitry of data processing network, where the write gather circuitry is configured to receive cracked writes transmitted across an interconnect of the data processing network from one or more data streams, each data stream associated with a stream identifier, where a write gathering buffer of one or more write gathering buffers of the write gather circuitry is configured to:
gather one or more cracked writes received at the write gather circuitry in accordance with a stream identifier until occurrence of one or more of:
the last write of a stream is gathered,
the write gathering buffer fills, or
the write gathering buffer is evicted for re-use; and
transmit the gathered one or more cracked writes in a gathered write burst to an external interface of the data processing network.

19. The non-transitory computer-readable medium of claim 18, where the computer-readable code designates a number of the one or more write gathering buffers in the write gather circuitry and the number is based on the number of unique write steams across the interconnect.

20. The non-transitory computer-readable medium of claim 18, where the computer-readable code designates a depth of each of the one or more write gathering buffers of the write gather circuitry and the depth of each of the one or more write gathering buffers is based on the maximum payload size settings of a controller of the data processing network.
